(19) United States
(12) Patent Application Publication
(10) Pub. No.: US 2005/0156350 A1
(43) Pub. Date: Jul. 21, 2005

(54) Multipurpose lab vessel and method

(76) Inventor: Syed Rehan, Tustin, CA (US)

Correspondence Address: LAW OFFICES OF CLEMENT CHENG, 17220 NEWHOPE STREET #127, FOUNTAIN VALLEY, CA, 92708, US

(21) Appl. No.: 10/759,659

(22) Filed: Jan. 16, 2004

(51) Int. Cl. B29B 15/00

(52) U.S. Cl. 264/232

(57) ABSTRACT

A plastic lab bottle created by an injection blow molding process comprises the steps of injecting plastic into a first mold from the plastic lab bottle bottom to form a preformed plastic lab bottle; blowing the preformed plastic lab bottle into a second mold by injecting air into the preformed plastic lab bottle through the mouth opening of the preformed plastic lab bottle; ejecting the finished plastic container from the second mold; providing a plastic cap for closing the bottle; and pulling the tether ring over the neck ring of the bottle.

### DISCUSSION OF RELATED ART

Vessels used in life science research labs are traditionally formed of glass. These traditionally glass containers are susceptible to cracking, exploding, shattering and can cause injuries due to the razor sharp edges of the pieces of broken glass during normal utility. A variety of specialized and general laboratory bottles have been invented including the Erlenmyer flask, the beaker, the Fembach flask, the volumetric flask, the jar, wide mouth bottle, narrow mouth bottle, square bottle, and dilution bottle. Many of these vessels are formed with various plastic resins, however due to inertness the glass vessels remain the chosen container for microbial culture media preparation by terminal sterilization.

Until now, glass containers have been the primary vessels that have been used for terminal sterilization of culture media and related biological fluids with fully engaged/tightened cap on the sterilization vessels as they can withstand the pressure and temperature associated with the autoclaving of closed container, however if there is a weak spot in glass, the bottles build up an aerosol pressure that can cause the bottle to burst, and spill out the contents as well as cause significant damage especially if failure occurs near operators or laboratory personnel. Exploding fluids that have been raised to temperatures of 121 C at 15 PSI cause severe burns.

Fluids, such as culture medium for growing a wide variety of microbial organisms are prepared in such vessels. Such fluids are made from powder that is hydrated and then sterilized in an autoclave by subjecting the content and the vessel to a temperature of 121 C at 15 PSI for 30 minutes to 45 minutes. The fluids are usually sterilized in glass bottles with the cap closed allowing the outside of the bottle to be sterilized as well as allowing the inside of the bottle and its content to be sterilized. When using a plastic bottle, a user commonly loosens the cap sterilizing the outside of the bottle as well as the inside. The user must then cool the bottle content before fully engaging the cap for an airtight seal. Once the sterilization cycle is completed the vessels are removed from autoclave to allow a normalization of content reach room temperature so the operator can move the vessels. While the content is cooling, the loose cap can allow the transfer of air and microbes may enter due to exchange of air into the contents of the plastic bottle. Contamination is costly in time and money as the contents cannot be used, and are deemed unacceptable for laboratory work. It defeats the purpose of sterilization and the process has to be repeated again.

Laboratory bottle made of plastic resin such as a polycarbonate LEXAN™ made by GE is shatter proof and does not explode causing damage to the user. Such plastic used must be extremely durable, resistant to leaching, inert to most chemical reactions, resistant to staining, resistant to retaining odors and must be able to withstand temperatures from −135° C. (−211° F.) to 135° C. (275° F.). This temperature and pressure is enough to cause shattering of glass bottles and implosion of ordinary plastic bottles. Polycarbonate plastic has been used for laboratory bottles. Because glass bottles can break and are not as safe as plastic bottles, laboratory consumers have used plastic bottles where plastic bottles can be used. Plastic bottles continue to have limitations such as loss of strength at high temperatures and therefore have not been used in the production of culture media through terminal sterilization. The prohibitive cost of such plastic containers have also forced the suppliers of media to use glass that is cheaper, but much heavier and less safe then other alternative.

The vessel closure is typically made with virgin, high-temperature polypropylene (PP). The cap is liner-free relying on a seal ring molded inside the cap and fitting tightly against the bottle neck to insure a leak-proof system. Threads on both bottle and cap are usually continuous and straight-shouldered, semi-buttress threads to again insure a leak-proof system. The base is usually broad and stable so that the bottle will not tip over during fill. The base often includes molded text information such as resin code, a recycling code, and the fill capacity. The typical wall thickness is uniform having beveled edges.

Plastic bottles manufactured according to current methods have a number of flaws. Many plastic bottles must be cleaned and but cannot be autoclaved during laboratory procedure. Plastic bottles can collapse if they are autoclaved with the cap sealed. Also, the handling of the cap by a user can contaminate the contents. A biology lab is a fertile environment for microbes, therefore microbial contamination is a very real and prevalent occurrence. When a user places the cap on the laboratory table, a variety of contaminants can enter the bottle through the cap.

Presently, the industry lacks a single, universally safe, chemically inert, shatterproof, implosion/explosion resistant, non-hazardous, multipurpose laboratory vessel for microbial media preparation, terminal sterilization, performing suspension culture, media packaging, media storage, contamination control, and transportation of sterile media fluids.

### OBJECTS OF THE INVENTION

The first object of the invention is to use a safe and multipurpose vessel that allows for terminal sterilization without implosion or explosion when the cap is secured. The second object of the invention is to deter contamination during normalization of temperature after sterilization. The third object of the invention is to create a safe, shatterproof, implosion resistant, explosion proof, non-hazardous, multipurpose laboratory vessel for microbial culture media preparation, terminal sterilization, suspension culture, media packaging and storage, contamination control, and safe, leakage-free transportation of sterile media fluids.

### BRIEF DESCRIPTION OF THE DRAWINGS

FIG. 1 is a side view of the first embodiment in closed position.

FIG. 2 is a side view of the first embodiment in open position.

FIG. 3 is a perspective view of the second embodiment in closed position.

FIG. 4 is a perspective view of the second embodiment in open position.

FIG. 5 is a bottom view of the second embodiment in closed position.

FIG. 6 is a top view of the second embodiment in closed position.

FIG. 7 is a top view of the second embodiment in open position.

FIG. 8 is an isometric view of the third embodiment in closed position.

### DETAILED DESCRIPTION OF THE PREFERRED EMBODIMENT

The present invention can be formed in a variety of shapes and sizes. Figure one shows a small bottle having a narrow mouth and small cap. Figure eight shows a larger bottle having a wide mouth and a larger cap with the sidewall bearing a swirl design.

The bottle is created by an injection blow molding process. The injection blow molding process begins with an injection step where plastic is injected into an injection mold, a blow mold step where plastic is injected into a blow mold and a final step where the finished product is ejected from the blow mold.

The shoulder arc is the junction of the shoulder and vertical cylindrical portion of the bottle. The shoulder arc preferably has a radius. The base arc preferably has a radius also and is a junction of the vertical cylindrical portion of the bottle and the base. The base is commonly circular in shape having a base rim.

Injecting plastic from the container base into a first mold or preform mold forms a preform piece having an annular bump around the shoulder and annular bump or protrusion around the base. The bump is gradual and appears smooth to the touch presenting a momentary thicker cross section. The annular nature of the bump allows a continuous ring around the shoulder and base arc of the preform piece. The protrusion can be formed on the inside or the outside of the piece. It is preferred to form the bump on the inside of the pre form piece. The shape of the protrusion is shallow and is positioned so that the final arc of the shoulder and arc of the base is slightly thicker by approximately one-tenth of an inch.

Alternatively, injecting plastic from the container base into a first mold can form a piece having an annular bump around the neck and base arc instead of the shoulder and base arc. Here, the shape of the protrusion is shallow and is positioned so that the final arc of the neck and arc of the base is slightly thicker by approximately one-tenth of an inch.

The neck arc is the area where the vertical wall of the neck meets the angle wall of the shoulder. The shoulder arc is the junction of the shoulder and vertical cylindrical portion of the bottle. The shoulder arc preferably has a radius. The base arc preferably has a radius also and is a junction of the vertical cylindrical portion of the bottle and the base. The base is commonly circular in shape having a base rim.

After the protrusion is placed on the preform mold, more than a single trial will be necessary, but excessive experimentation would not be required. Numerous factors complicate and prevent a mold designer from reaching a perfected product in the first trial. Depending upon the shape of the final product, the mold designer may require a number of trials and wasted material before perfecting the production mold. Phase change and crystallization induces substantial deformation and residual stresses that weakens the final bottle and modifies its thickness profile. During the blowing phase, the preform plastic part is blown like a balloon to final dimensions. Viscoelastic effects including strain hardening limit stretching in certain locations. Plastic coming in first contact with the mold deforms less. Thus, final thickness requires considering the initial thickness of the preform piece in addition to related industry variables. Electronic computer calculations of blow molding simulation can account for whether parison or preform mold is flying in open room or whether it is in contact with a mold. Numerical algorithms allow complex geometry calculation shortening the number of trials required for practicing the invention.

Blowing the preform plastic into a second mold by injecting air through the opening of the preform mold forms a finished plastic container 10 shaped with an annular protrusion around the shoulder arc 150 and annular protrusion around the base arc 160 forming a thicker wall at the base and shoulder before ejecting the finished plastic container from the second mold. The preform piece produced can be air blown and stretched to accommodate from 250 ml to 1250 ml of volume by varying the diameter.

The wall of the polycarbonate bottle is not uniform and ranges in thickness from 7 mm at the side wall 140 to 9 mm at the neck arc and base arc areas allowing a user to close the cap forming an airtight seal inside the chamber and allowing a user to autoclave the bottle without risk of implosion for sterilizing the outside surface of the bottle. This ratio can be further improved by changing the topography of the vessel such as changing the shape from round to octagonal of adding baffles or wavy patterns.

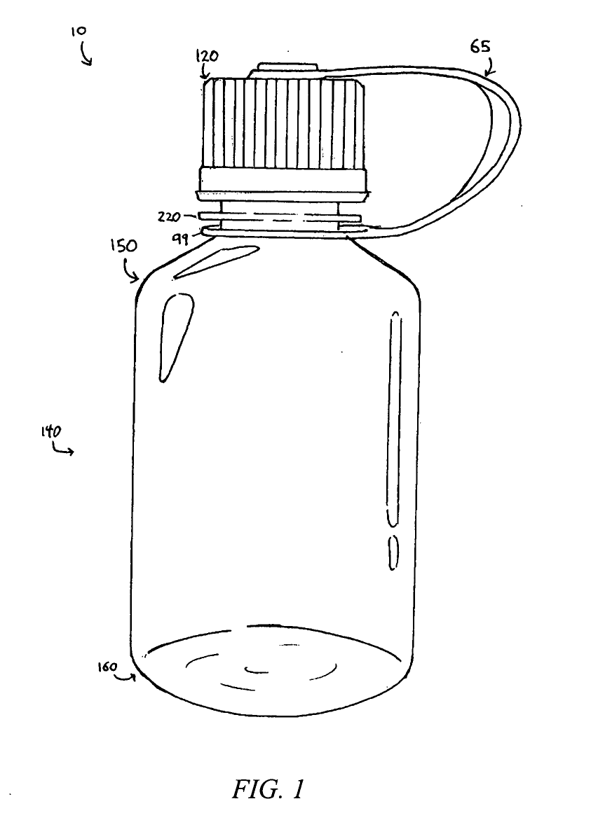

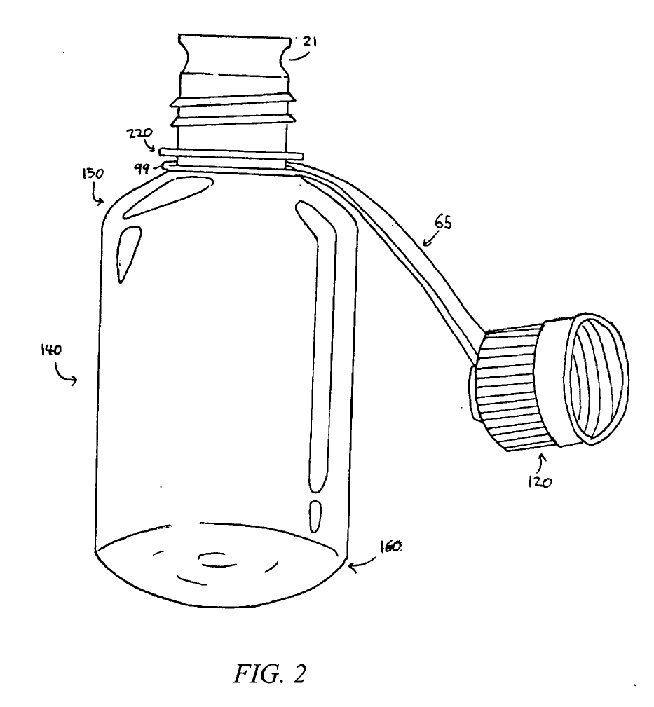

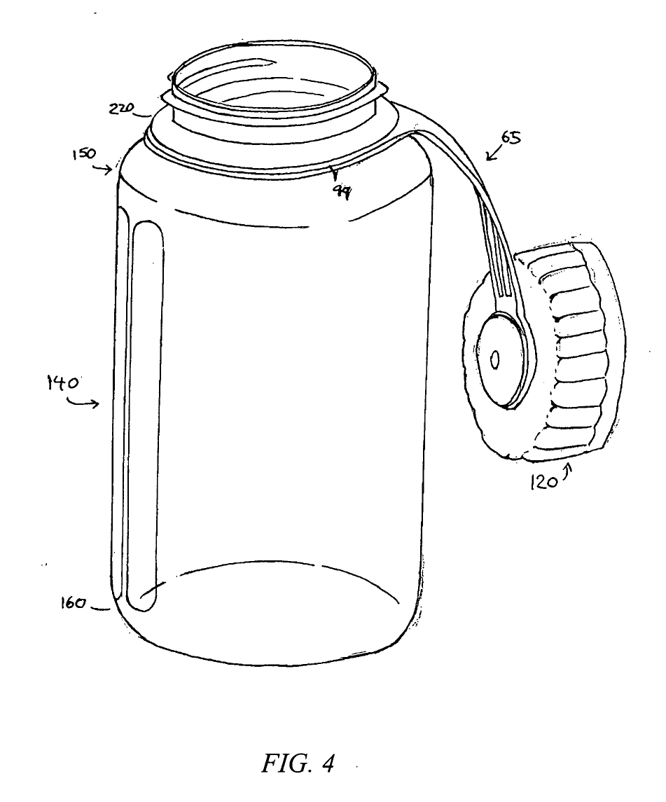

A neck ring 220 insures security of shrink-wrapped seals. The neck ring has a smooth interior so there is no fluid entrapment and no back-flow contamination. The bottle holds a tether 65 at a first end of the retaining neck ring attaching to the retaining neck ring rim provided on the bottle. The tether 65 has a second end attached to the cap 120 of the bottle. The plastic cap is tethered to a tether ring 99, FIG. 4, FIG. 1, FIG. 2. that can fit over the neck ring of the bottle. The tether ring is elastic so that it can stretch over the neck ring 220 of the bottle. The tether 65 formed as a band terminates at a first end with a plastic cap 120 and terminates at an opposite end with the tether ring 99. The container can be used for storage in the closed position. The container can also be used to transport contents while the cap is in closed position.

The loop top tether 65 is a flat band having calibrated stiffness allowing an open cap to rest in open extended position suspended in midair as shown in FIG. 2 and FIG. 4. The cap can rest without touching the bottle or resting surface such as lab table. The stiffness is not so great as to bias the cap back into closed position. The tether band is formed of a flexible plastic material having a spring force calibrated to hang at the side of the bottle 140 without touching the bottle 140 or table as shown in figure two.

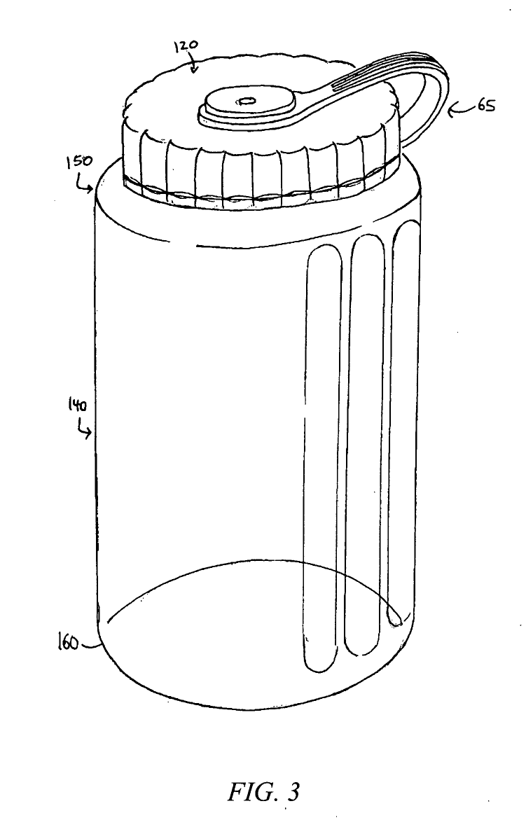

As shown in FIG. 3, the cap 120 can cover the neck ring so that the cap is seen while the neck ring is not seen. When a user removes the cap 120 the neck ring 220 is exposed as well as the tether ring 99. The band 65 has optionally indentations 35 allowing calibration of stiffness.

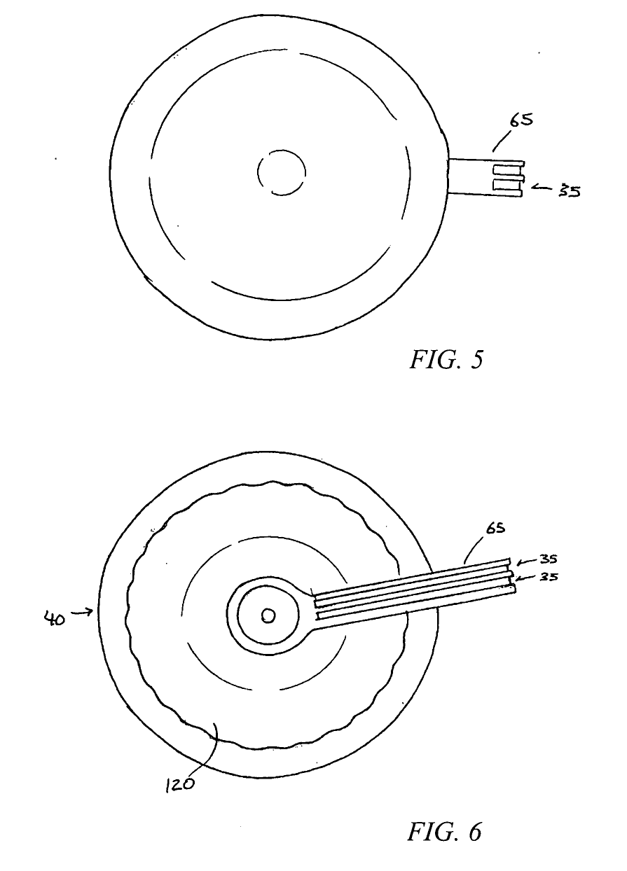

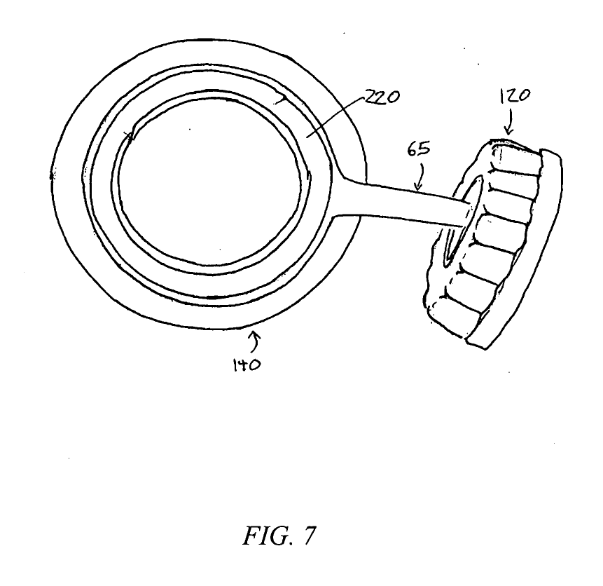

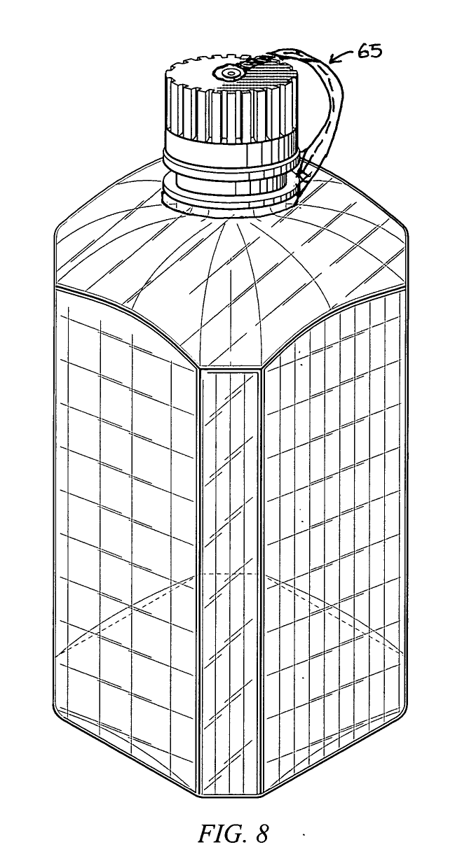

Parallel grooves 35 formed in the outside of the tethered band 65 can be used to change the stiffness and resilience of the band as seen FIG. 5 and FIG. 6. Additional grooves allow a less stiff band and can be matched with caps so that heavier caps receive stiffer bands.

The polycarbonate container does not leach or add contaminants into the contents during the autoclave process. The culture media remains inside the container during the autoclave process. The culture media is usable for all appropriate microbial culture applications while maintaining sterility. The contents can then be shipped using commercial carriers without concern of leakage or transferring contaminants into or out of the vessel. If the temperature exceeds the norm in the autoclave, or if the autoclave is mis-calibrated, or is opened prematurely causing significant change in pressure the vessel does not explode as it has ample flexibility to distort and stretch.

The method of using the flask allows a closed system for culturing of microbes in suspension cultures that minimizes the risk of contamination and accidental material failure of the flask. The vessel is an alternative to the Erlenmeyer glass flasks that are used as intermediary vessels after terminal sterilization of fluids used for microbial culture.

A user dispenses the microbial culture fluid into the vessel. A user does not need to transfer sterile fluids into a new vessel thus preventing contamination possibilities. The microbial culture fluid is dispensed into the container through the opening in the container. The user can hand seal the fluid inside the container by closing the cap. The user sterilizes the culture by autoclaving the flask with contents inside. The user keeps the fluid closed within the container and optionally places a shrink wrap seal over the shrink wrap neck ring. The user can collect a large number of the flasks processed similarly, package them and put them on a pallet for shipping to a second location. The user minimizes washing of glass vessels, and saves considerable time to begin the culture.

The culture can be prepared shipped and grown in the same vessel. The same vessel again has accommodation for fitting in a shaking incubator for suspension. When the shipment arrives from the first location to the second location, the user can unload the pallets and transport the flasks from the warehouse to the laboratory, without the fear of contamination of the sterile media. If a user accidentally drops one or more of the bottles, the media remains sterile and can be used with confidence. The bottle is shatterproof and can withstand stress of falling from as much as 12 feet. In the laboratory, the user prepares the bottle by removing the optional shrink wrap seal that is fitted over the shrink wrap neck ring. The shrink wrap can be recycled. The user then opens the cap so that the cap hangs from the tether. The tether is calibrated allowing the cap to hang in midair without touching the bottle, or the laboratory bench, leaving the users hand free to perform lab procedure. The user dispenses microbes into the bottle and closes the bottle cap on the bottle. The user can then put the bottle into a shaker device that agitates the bottle and contents for mixing. After mixing, the bottle can be placed into a temperature controlled area allowing microbe growth. After a predetermined time, the bottle can be repackaged. Optionally, a second shrink wrap seal can be fitted over the shrink wrap neck ring. After the bottle is packed, the user can ship the bottle to a second laboratory for collection of microbes of interest and further analysis, Nucleic acid purification, protein purification, gene expression or related studies.

Finally, terminal sterilization can be performed before disposal of the bottle and contents to eliminate biological hazard.

1. A plastic lab bottle created by an injection blow molding process comprising the steps of:
injecting plastic into a first mold from the plastic lab bottle bottom to form a preformed plastic lab bottle, wherein the preformed plastic lab bottle has an annular protrusion around the shoulder arc and annular protrusion around the base arc;
blowing the preformed plastic lab bottle into a second mold by injecting air into the preformed plastic lab bottle through the mouth opening of the preformed plastic lab bottle forming a finished plastic container, the annular protrusion around the shoulder arc in the preformed plastic lab bottle forming a thicker wall at the shoulder arc, the annular protrusion around the base arc in the preformed plastic lab bottle forming a thicker wall at the base arc;
ejecting the finished plastic container from the second mold;
providing a plastic cap for closing the bottle, the plastic cap tethered by a tether to a tether ring that can fit over the neck ring of the bottle, wherein the tether is calibrated in stiffness allowing an open cap to rest in open extended position suspended in midair;
pulling the tether ring over the neck ring of the bottle.

2. The plastic lab bottle of claim 1, wherein the wall of the polycarbonate bottle is not uniform and ranges in thickness from 7 mm at the side wall to 9 mm at the neck arc and base arc areas.

3. The plastic lab bottle of claim 1, wherein the band has indentation grooves allowing calibration of stiffness.

4. The plastic lab bottle of claim 1, wherein band stiffness is matched to cap weight allowing an open cap to rest in open extended position suspended in midair.

5. A method of making a plastic lab bottle by an injection blow molding process comprising the steps of:
injecting plastic into a first mold from the plastic lab bottle bottom to form a preformed plastic lab bottle, wherein the preformed plastic lab bottle has an annular protrusion around the shoulder arc and annular protrusion around the base arc;
blowing the preformed plastic lab bottle into a second mold by injecting air into the preformed plastic lab bottle through the mouth opening of the preformed plastic lab bottle forming a finished plastic container, the annular protrusion around the shoulder arc in the preformed plastic lab bottle forming a thicker wall at the shoulder arc, the annular protrusion around the base arc in the preformed plastic lab bottle forming a thicker wall at the base arc;
ejecting the finished plastic container from the second mold;
providing a plastic cap for closing the bottle, the plastic cap tethered by a tether to a tether ring that can fit over the neck ring of the bottle, wherein the tether is calibrated in stiffness allowing an open cap to rest in open extended position suspended in midair;
pulling the tether ring over the neck ring of the bottle.

6. The plastic lab bottle of claim 1, wherein the wall of the polycarbonate bottle is not uniform and ranges in thickness from 7 mm at the side wall to 9 mm at the shoulder arc and base arc areas.

7. The plastic lab bottle of claim 1, wherein the band has indentation grooves allowing calibration of stiffness.

8. The plastic lab bottle of claim 1, wherein the wall of the polycarbonate bottle is not uniform and ranges in thickness from 7 mm at the side wall to 9 mm at the shoulder arc and base arc areas.

9. The plastic lab bottle of claim 1, wherein band stiffness is matched to cap weight allowing an open cap to rest in open extended position suspended in midair.

10. The method of making microbial culture in a plastic lab bottle comprising the steps of:
injecting plastic into a first mold from the plastic lab bottle bottom to form a preformed plastic lab bottle, wherein the preformed plastic lab bottle has an annular protrusion around the shoulder arc and annular protrusion around the base arc;
blowing the preformed plastic lab bottle into a second mold by injecting air into the preformed plastic lab bottle through the mouth opening of the preformed plastic lab bottle forming a finished plastic container, the annular protrusion around the shoulder arc in the preformed plastic lab bottle forming a thicker wall at the shoulder arc, the annular protrusion around the base arc in the preformed plastic lab bottle forming a thicker wall at the base arc;
ejecting the finished plastic container from the second mold;
providing a plastic cap for closing the bottle, the plastic cap tethered by a tether to a tether ring that can fit over the neck ring of the bottle,
pulling the tether ring over the neck ring of the bottle;
dispensing microbial culture into the bottle through the opening; sealing the microbial culture inside the bottle by closing the cap; sterilizing the culture by autoclaving the bottle with contents closed inside; keeping the fluid closed within the bottle; and optionally places a shrink wrap seal over the shrink wrap neck ring;
opening the cap so that the cap hangs from the tether; dispensing microbes into the bottle;
closing the bottle cap on the bottle.

11. The method of claim 10 further including the step of shipping the bottle to a second location.

12. The method of claim 10, wherein the wall of the polycarbonate bottle is not uniform and ranges in thickness from 7 mm at the side wall to 9 mm at the shoulder arc and base arc areas.

13. The method of claim 10, wherein the band has indentation grooves allowing calibration of stiffness.

14. The method of claim 10, wherein band stiffness is matched to cap weight allowing an open cap to rest in open extended position suspended in midair.

15. The method of claim 10 further including the step of shaking the bottle into a device that agitates the bottle and contents for mixing.

16. The method of claim 10, wherein the wall of the bottle is made of a plastic other than polycarbonate.

17. A plastic lab bottle created by an injection blow molding process comprising the steps of:
injecting plastic into a first mold from the plastic lab bottle bottom to form a preformed plastic lab bottle, wherein the preformed plastic lab bottle has an annular protrusion around the neck arc and annular protrusion around the base arc;
blowing the preformed plastic lab bottle into a second mold by injecting air into the preformed plastic lab bottle through the mouth opening of the preformed plastic lab bottle forming a finished plastic container, the annular protrusion around the neck arc in the preformed plastic lab bottle forming a thicker wall at the neck arc, the annular protrusion around the base arc in the preformed plastic lab bottle forming a thicker wall at the base arc;
ejecting the finished plastic container from the second mold;
providing a plastic cap for closing the bottle, the plastic cap tethered by a tether to a tether ring that can fit over the neck ring of the bottle, wherein the tether is calibrated in stiffness allowing an open cap to rest in open extended position suspended in midair;
pulling the tether ring over the neck ring of the bottle.

18. The plastic lab bottle of claim 1, wherein the wall of the polycarbonate bottle is not uniform and ranges in thickness from 7 mm at the side wall to 9 mm at the neck arc and base arc areas.

19. The plastic lab bottle of claim 1, wherein the band has indentation grooves allowing calibration of stiffness.

20. The plastic lab bottle of claim 1, wherein band stiffness is matched to cap weight allowing an open cap to rest in open extended position suspended in midair.
